(19) United States
(12) Patent Application Publication
(10) Pub. No.: US 2012/0233938 A1
(43) Pub. Date: Sep. 20, 2012

(54) Modular System

(75) Inventors: Fred Siegel, Philadelphia, PA (US); Klaus Rosburg, Brooklyn, NY (US); Jerry Zucker, Los Angeles, CA (US)

(73) Assignee: Happy Cabinet, LLC, Los Angeles, CA (US)

(21) Appl. No.: 13/513,298

(22) PCT Filed: Dec. 1, 2010
(86) PCT No.: PCT/US10/58506

§ 371 Date: Jun. 1, 2012

Related U.S. Application Data
(60) Provisional application No. 61/266,154, filed on Dec. 2, 2009.

(51) Int. Cl. E04C 2/38; E04H 14/00; B23P 17/04

(52) U.S. Cl. 52/173.1; 29/525.01; 52/588.1

(57) ABSTRACT

A modular tile adapted for mounting onto a flat surface, comprising an edge connector; an edge receiver configured to accommodate the connector; and a plurality of flat units, wherein each unit comprises a central opening with two dimensions with a first dimension smaller than a second dimension. The modular tiles are connected by releasably securing an edge connector of a first modular tile to an edge receiver of a second modular tile.

### CLAIM FOR PRIORITY

This application claims priority under 35 U.S.C. §119(e) to U.S. patent application Ser. No. 61/266,154 filed on Dec. 2, 2010, which is incorporated by reference in its entirety.

### TECHNICAL FIELD

This invention relates to a modular system for storage, for example, by tiling in a cabinet, closet or on a wall. The modular tile can include an edge connector and a plurality of flat units.

### BACKGROUND

Medicine cabinets and bathroom storage cabinets have been used in many residential homes. These cabinets are typically made of aluminum or steel.

### SUMMARY

A modular tile adapted for mounting onto a flat surface can include an edge connector, an edge receiver configured to accommodate the connector, and a plurality of flat units. Each unit can include a central opening with two dimensions with a first dimension smaller than a second dimension. At least two modular tiles can be connected by releasably securing an edge connector of a first modular tile to an edge receiver of a second modular tile. The modular tile can include a four-by-four (4×4) or an eight-by-eight (8×8) unit configuration. The modular tile can include a metal or plastic. Each flat unit can be in a shape of a square or hexagon. The modular tile can include an organizing unit having a rear mounting member configured to releasably secure to the modular tile by engaging at least one central opening and extending into a region between the first dimension and the second dimension. The organizing unit can be a drawer unit, a storage cube, a utility clip or a hook.

A modular system can include a housing adapted for mounting onto a flat surface and a tile. The housing can include a rear wall joined to a forwardly projecting top wall, bottom wall, and a pair of side walls to define a forwardly open chamber. The tile can be attached to the rear wall of the housing. The tile can include a plurality of flat units. Each unit can include a central opening with two dimensions with a first dimension smaller than a second dimension. The system can include an organizing unit having a rear mounting member configured to releasably secure to the modular tile by engaging at least one central opening and extending into a region between the first dimension and the second dimension. The organizing unit can be a drawer unit, a storage cube, a utility clip or a hook.

An organizer system can include at least one modular tile and an organizing unit. The modular tile can include an edge connector, an edge receiver configured to accommodate the connector, and a plurality of flat units. Each unit can include a central opening with two dimensions with a first dimension smaller than a second dimension. The organizing unit can include a rear mounting member configured to releasably secure to the modular tile by engaging at least one central opening and extending into a region between the first dimension and the second dimension.

The organizing unit can be a drawer unit, a storage cube, a utility clip or a hook. The rear mounting member can be configured to engage at lease two regions of the central opening.

A method of assembling a modular tiling system can include providing at least two modular tiles. Each modular tile can include an edge connector, an edge receiver configured to accommodate the connector, and a plurality of flat units. Each unit can include a central opening with two dimensions with a first dimension smaller than a second dimension. The method can include connecting two modular tiles by releasably securing a edge connector of a first modular tile to a edge receiver of a second modular tile and mounting the assembled modular tiles onto a flat surface.

Each modular tile can include a four-by-four (4×4) unit configuration or an eight-by-eight (8×8) unit configuration. The modular tile can include a metal or a plastic. Each flat unit can be in a shape of a square or a hexagon. The method can further include releasably securing an organizing unit having a rear mounting member to the modular tile by engaging at least one central opening and extending into a region between the first dimension and the second dimension. The organizing unit can be a drawer unit, a storage cube, a utility clip or a hook.

In another aspect, a method of assembling a modular system can include providing a first modular tile and a housing and securing the tile to a rear wall of a housing. Each modular tile can include an edge connector, an edge receiver configured to accommodate the connector, and a plurality of flat units, each unit including a central opening with two dimensions with a first dimension smaller than a second dimension. The method can further include providing a second modular tile and mounting the second modular tile onto a wall of the housing including engaging the edge connector of the first modular tile with the edge receiver of the second modular tile or engaging the edge connector of the second modular tile with the edge receiver of the first modular tile. The modular tile can include a four-by-four (4×4) unit configuration or an eight-by-eight (8×8) unit configuration. The modular tile can include a metal or a plastic. Each flat unit can be in the shape of a square or a hexagon. The method can further include releasably securing an organizing unit having a rear mounting member to the modular tile by engaging at least one central opening and extending into a region between the first dimension and the second dimension. The organizing unit can be a drawer unit, a storage cube, a utility clip or a hook.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1 illustrates a modular tile.

FIG. 1A illustrates a cross section of a modular tile.

FIG. 2 illustrates a modular tile.

FIG. 3 illustrates a housing of a modular tiling cabinet.

FIG. 4 illustrates a modular tiling cabinet.

FIG. 5 illustrates a modular tiling cabinet.

FIG. 6 illustrates a modular tiling cabinet.

FIG. 7 illustrates a modular tiling cabinet.

FIG. 8 illustrates a modular tiling cabinet.

FIG. 9 illustrates a modular tiling cabinet.

FIG. 10 illustrates a modular tiling cabinet.

FIG. 11 illustrates a modular tiling cabinet.

FIG. 12 illustrates a modular tiling cabinet.

FIG. 13 illustrates a modular tiling cabinet.

### DETAILED DESCRIPTION

Medicine cabinets and bathroom storage cabinets have been used in many residential homes. The vast majority of these cabinets consist of a mirrored door that swings open, revealing two or three shelves inside the cabinet structure. These shelves often are made of glass and rest on metal or plastic clips to enable them to be adjusted higher or lower within the cabinet. Occasionally, these shelves are made of metal or strong plastic, and most of the shelves are moveable to different heights within the cabinet, or are able to be removed completely. These cabinets are typically made of aluminum or steel.

A modular tiling system is developed to create storage space in any cabinet, storage room, kitchen area, closet, or wall. The modular tiling system is easy to assemble and customizable to any room, whether to store tools, hardware, or garden supplies, or pots, pans, kitchen tools, etc. It can be used for bathroom storage cabinets, to create more storage capacity and organization to items stored in the cabinets. Moreover, the modular tiling system can also be used in kitchen, garage, or any residential or small commercial application where organization of storage is desired.

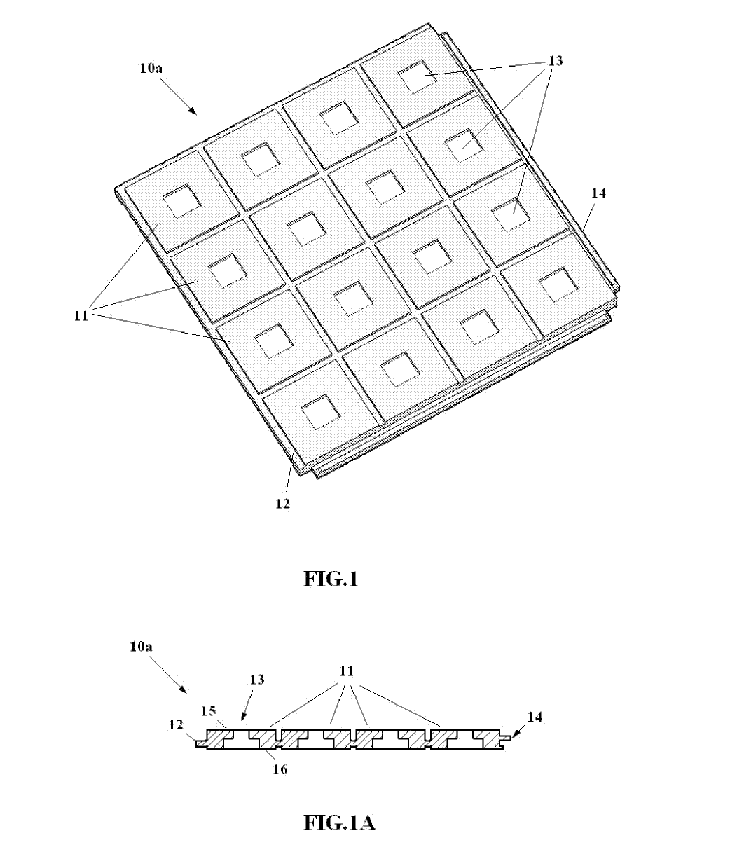

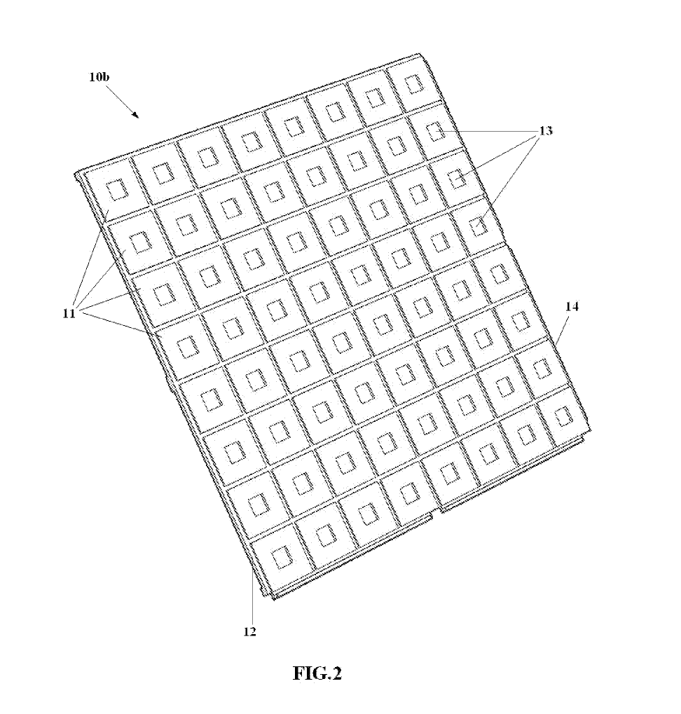

As shown in FIGS. 1, 1A, and 2, a modular tile can include edge connector 12, edge receiver 14, and a plurality of flat units 11. Edge receiver 14 can be configured to accommodate connector 12. Each unit 11 can have first surface 15, second surface 16, and central opening 13. Central opening 13 can have two dimensions. The part of opening 13 adjacent to first surface 15 can have a first dimension smaller than a second dimension of the part of opening 13 adjacent to second surface 16. In FIG. 1, modular tile 10a can have a four-by-four (4×4) unit configuration. In FIG. 2, modular tile 10b can have an eight-by-eight (8×8) unit configuration. In some embodiments, modular tile can have any suitable configuration, such like 2×4, 3×3, 3×5, 5×5, 5×6, 5×7, 7×7, 5×8, or 6×8. Two modular tiles can be connected by releasably securing an edge connector of a first modular tile to an edge receiver of a second modular tile. In other embodiments, modular tile can have a uniform configuration, such as 10×10 or larger, which can be further dissembled and resembled to any customizable smaller configuration and dimension.

The modular tile can include a metal or plastic. Each flat unit can be in the shape of a square, hexagon, rectangle, triangle, parallelogram, rhombus, or any suitable polygon.

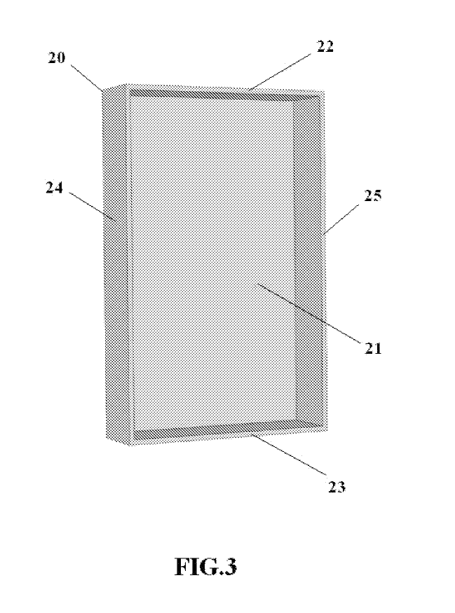

As shown in FIG. 3, a modular tiling cabinet can include housing 20 adapted for mounting onto a flat surface. Housing 20 can include rear wall 21 joined to forwardly projecting top wall 22, bottom wall 23, and a pair of side walls 24 and 25 to define a forwardly open chamber.

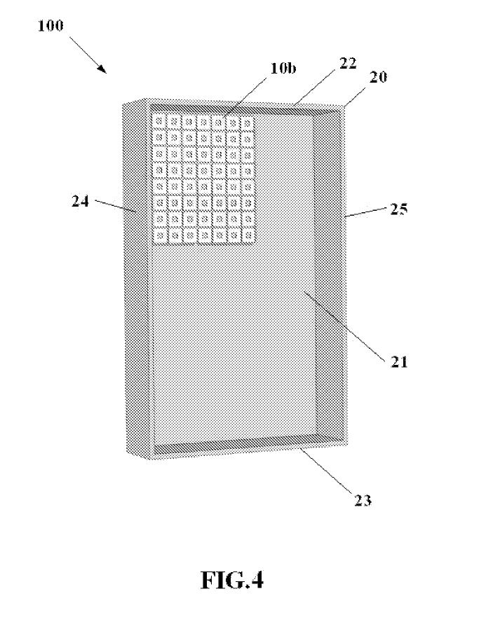

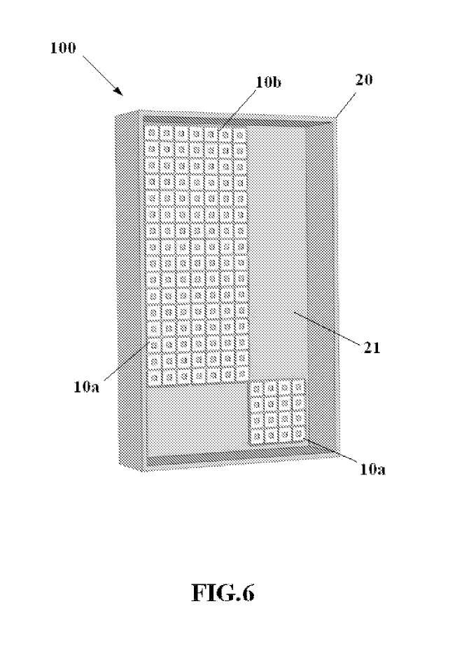

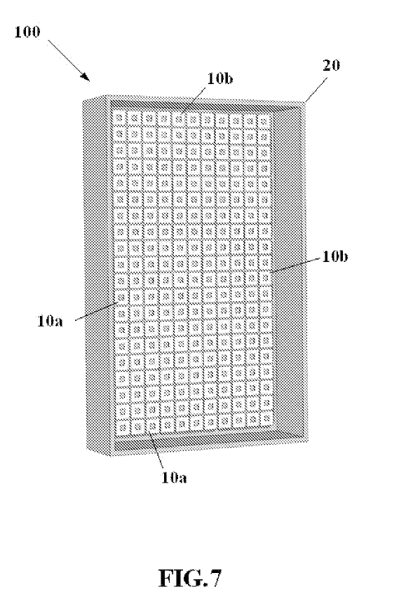

As shown in FIGS. 4 through 7, modular tiling cabinet 100 can include housing 20 and at least one modular tile 10a or 10b. The tile can be attached to rear wall 21 of housing 20 with screws or adhesive tape. As can be found in the figures, a larger tile, such as 10b, can be attached to rear wall 21 and smaller tiles, such as 10a, can be used to fill in the remaining uncovered space of rear wall 21 of cabinet 100, creating a panel that covers maximum surface area of rear wall 21.

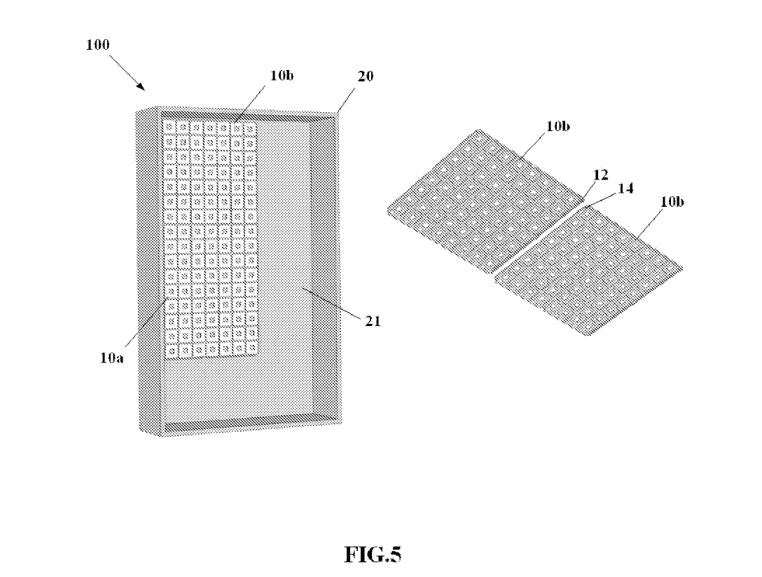

Before being mounted onto the rear wall, two modular tiles (10b in FIG. 5) can be connected by releasably securing an edge connector (12 in FIG. 5) of a first modular tile to an edge receiver (14 in FIG. 5) of a second modular tile.

In other embodiments, a method of assembling a modular system can include providing a first modular tile (10b in FIG. 5) and a housing (20 in FIG. 5) and securing the tile to a rear wall of a housing. Each modular tile can include an edge connector, an edge receiver configured to accommodate the connector, and a plurality of flat units, each unit including a central opening with two dimensions with a first dimension smaller than a second dimension. The method can further include providing a second modular tile and mounting the second modular tile onto a wall of the housing including engaging the edge connector (12 in FIG. 5) of the first modular tile with the edge receiver (14 in FIG. 5) of the second modular tile or engaging the edge connector of the second modular tile with the edge receiver of the first modular tile.

In other embodiments, the modular tile can also be attached to a rear wall of any given cabinet. With the customizable configuration of modular tiles, the rear wall of the cabinet can have a maximum surface area coverage.

The modular tile can include an organizing unit having a rear mounting member configured to releasably secure to the modular tile by engaging at least one central opening and extending into a region between the first dimension and the second dimension. The organizing unit can be a drawer unit, a storage cube, a utility clip or a hook. The rear mounting member can be configured to engage at lease two regions of the central opening.

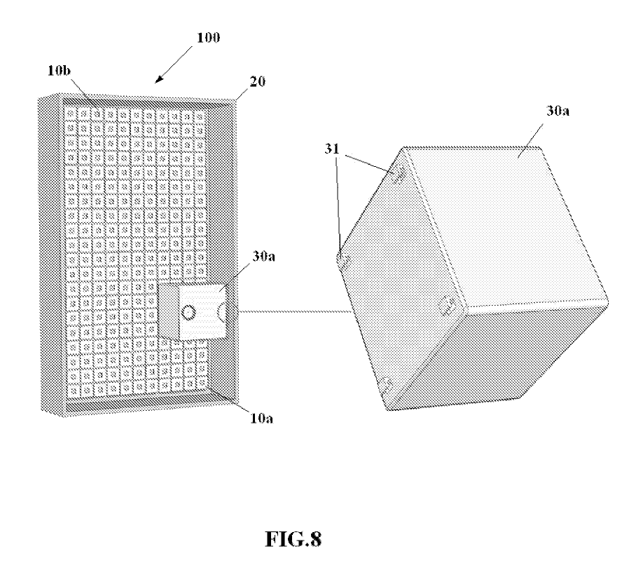

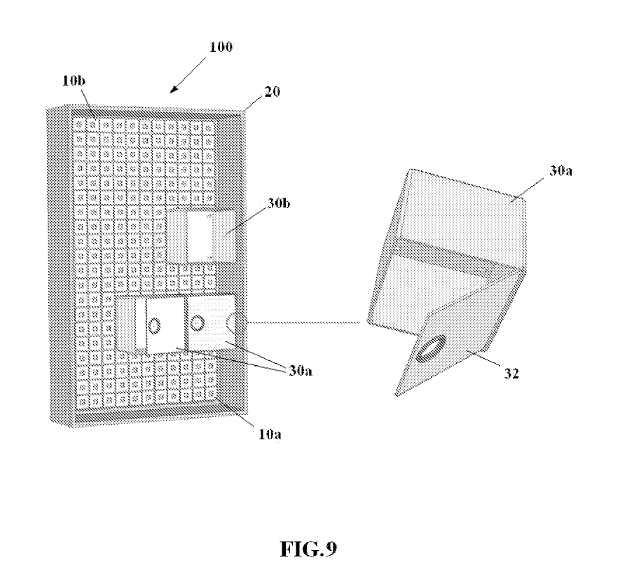

As shown in FIGS. 8 through 13, modular tiling cabinet 100 can further include any suitable organizational items in customizable ways. In FIGS. 8 and 9, storage cubes 30a and 30b can be releasably secured to a modular tile by inserting rear mounting member 31 into a central opening of a unit of the modular tile. A plurality of storage cubes, such as 30a and 30b, can be included in modular tiling cabinet 100 in a customizable way. Storage cube 30a can further have swing door 32.

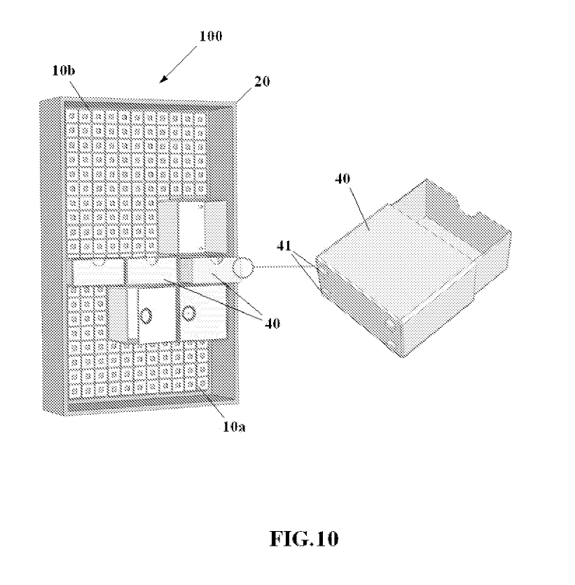

In FIG. 10, drawer 40 can be releasably secured to the modular tile by inserting rear mounting member 41 into a central opening of a unit of the modular tile. A plurality of drawers 40 can be included in modular tiling cabinet 100 in a customizable way.

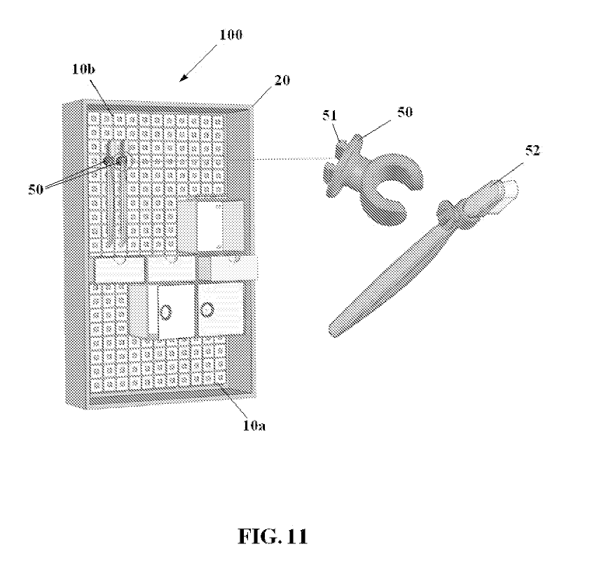

Likewise, in FIG. 11, utility clip 50 can be releasably secured to the modular tile by inserting rear mounting member 51 into a central opening of a unit of the modular tile. Utility clip 50 can be used to hold toothbrush 52 or any suitable tool or gadget.

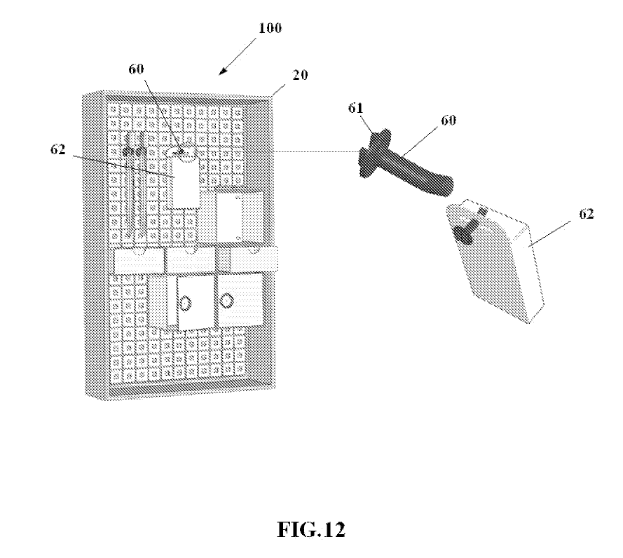

In FIG. 12, hook 60 can be releasably secured to the modular tile by inserting rear mounting member 61 into a central opening of a unit of the modular tile. Hook 60 can be used to hold storage box 62 or any suitable tool or gadget.

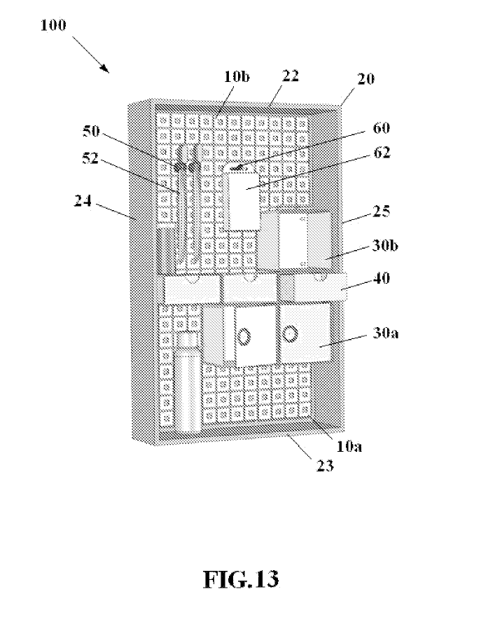

As shown in FIG. 13, modular tiling cabinet 100 can include any suitable organizational items, such as storage cubes 30a and 30b, drawer 40, utility clip 50, and hook 60, in customizable ways. Housing 20 can arranged to have space for other storage box, tool, or gadget.

The modular tiles, such as 10a and 10b, can be attached to rear wall 21 of housing 20 with screws or adhesive tape. In other embodiments, a hardware connector (e.g., a screw, nail, rivet, weld, adhesive, or braze joint) can be used to attach modular tile to rear wall 21.

In some embodiments, at least one hardware connector (e.g., a screw, nail, rivet, weld, adhesive, or braze joint) can be used to mount the modular tile to any suitable surface, such as a wall of a garage, rear wall of a closet, kitchen wall, or any surface that the homeowner chooses to use for organized storage.

While the invention has been shown and explained in the embodiment described herein, it is to be understood that the invention should not be confined to the exact showing of the drawings, and that any variations, substitutions, and modifications are intended to be comprehended within the spirit of the invention. Other embodiments are within the claims.

1. A modular tile adapted for mounting onto a flat surface, comprising
an edge connector;
an edge receiver configured to accommodate the connector; and
a plurality of flat units, wherein each unit comprises a central opening with two dimensions with a first dimension smaller than a second dimension.

2. The modular tile of claim 1, wherein at least two modular tiles are connected by releasably securing an edge connector of a first modular tile to an edge receiver of a second modular tile.

3. The modular tile of claim 1, comprising a four-by-four (4×4) unit configuration.

4. The modular tile of claim 1, comprising an eight-by-eight (8×8) unit configuration.

5. The modular tile of claim 1, comprising a metal.

6. The modular tile of claim 1, comprising a plastic.

7. The modular tile of claim 1, wherein each flat unit is in a shape of a square.

8. The modular tile of claim 1, wherein each flat unit is in a shape of a hexagon.

9. The modular tile of claim 1, comprising an organizing unit having a rear mounting member configured to releasably secure to the modular tile by engaging at least one central opening and extending into a region between the first dimension and the second dimension.

10. The modular tile of claim 1, wherein the organizing unit is a drawer unit, a storage cube, a utility clip or a hook.

11. A modular system, comprising:
a housing adapted for mounting onto a flat surface, the housing comprising a rear wall joined to a forwardly projecting top wall, bottom wall, and a pair of side walls to define a forwardly open chamber; and
a tile attached to the rear wall of the housing, the tile comprising a plurality of flat units, wherein each unit comprises a central opening with two dimensions with a first dimension smaller than a second dimension.

12. The system of claim 11, comprising an organizing unit having a rear mounting member configured to releasably secure to the modular tile by engaging at least one central opening and extending into a region between the first dimension and the second dimension.

13. The system of claim 11, wherein the organizing unit is a drawer unit, a storage cube, a utility clip or a hook.

14. An organizer system, comprising:
at least one modular tile, the modular tile comprising an edge connector, an edge receiver configured to accommodate the connector, and a plurality of flat units, wherein each unit comprises a central opening with two dimensions with a first dimension smaller than a second dimension; and
an organizing unit having a rear mounting member configured to releasably secure to the modular tile by engaging at least one central opening and extending into a region between the first dimension and the second dimension.

15. (canceled)

16. (canceled)

17. A method of assembling a modular tiling system, comprising:
providing at least two modular tiles, wherein each modular tile comprises:
an edge connector;
an edge receiver configured to accommodate the connector; and
a plurality of flat units, wherein each unit comprises a central opening with two dimensions with a first dimension smaller than a second dimension;
connecting two modular tiles by releasably securing a edge connector of a first modular tile to a edge receiver of a second modular tile; and
mounting the assembled modular tiles onto a flat surface.

18. The method of claim 17, wherein each modular tile comprises a four-by-four (4×4) unit configuration or an eight-by-eight (8×8) unit configuration.

19. The method of claim 17, wherein the modular tile comprises a metal or a plastic.

20. The method of claim 17, wherein each flat unit is in a shape of a square or a hexagon.

21. The method of claim 17, further comprising releasably securing an organizing unit having a rear mounting member to the modular tile by engaging at least one central opening and extending into a region between the first dimension and the second dimension.

22. The method of claim 17, wherein the organizing unit is a drawer unit, a storage cube, a utility clip or a hook.

23-29. (canceled)
